(19) United States
(12) Patent Application Publication
(10) Pub. No.: US 2025/0073601 A1
(43) Pub. Date: Mar. 6, 2025

(54) System and Method for Matching Players with Asymmetric Entry Fee and Payout in Virtual Games

(71) Applicant: M-League Ltd., Singapore (SG)

(72) Inventors: Yash Sharma, Dewas (IN); Aashay Sachdeva, Ghaziabad (IN); Arzoo Jain, Ghaziabad (IN); Rishi Swami, Bengaluru (IN); Kabir Rustogi, New Delhi (IN); Vibhav Viswanathan, Bangalore (IN)

(21) Appl. No.: 18/562,709

(22) PCT Filed: Aug. 3, 2023
(86) PCT No.: PCT/IB2023/057856

§ 371 Date: Nov. 20, 2023

(30) Foreign Application Priority Data
Jan. 24, 2023 (IN) 202311004762

(51) Int. Cl. A63F 13/795; A63F 13/798

(52) U.S. Cl. CPC A63F 13/795; A63F 13/798

(57) ABSTRACT

Disclosures of the present invention relate to a system and method of matching players intending to play a multiplayer online game. The system in the present invention matches players with asymmetric entry fee and payout amounts as well as also matching the players with different geographies, time zones and currencies. The system further employs skill based matchmaking to ensure fair play. Hence, the improved system and method is capable of matching players in online games with very low matchmaking times even during low concurrency periods.

This application claims benefit of complete application number IN202311004762 filed on 24 Jan. 2023

### FIELD OF INVENTION

Embodiments of the disclosure relate generally to the field of matching players in multiplayer online gaming systems. More particularly, embodiments of the disclosure relate to a method and system for matching players across multiple entry fees categories and payout rewards in multiplayer online gaming.

### BACKGROUND

With the proliferation of internet and low cost smartphones amongst urban and rural population, online gaming industry has grown leaps and bounds in past two decades. Gradually, traditional games are being replaced by online/video games, which have a direct effect on how internet users spend their free time. The rising popularity of online games has given birth to a new industry where the availability of platform and game distribution systems is a key factor in the explosion in online gaming interest. Expansion in the gaming industry can be attributed to growth in per capita income, rise in interest and the number of dual-income households, all of which are contributing to the market's transformation. Further, the recent COVID-19 outbreak has impacted the industry as rapid growth in terms of users and games downloaded was seen.

This ongoing market expansion has huge implications for the many businesses operating within the gaming ecosystem, including developers, distributors, content creators, and game platforms. Short or quick-to-play games have contributed heavily to this growth and now form one of the cornerstones in the online gaming industry, along with massively multiplayer online games. Quick-to-play games have shorter runtime, can be single player or multiplayer, and offer immediate thrill and excitement; thereby generally engaging players with shorter attention spans. To cater to the shorter attention spans, it is imperative that such online games offer fast or near-instant matchmaking. The process of matchmaking decides the players that are to be played together in a single instance of a game. The matchmaking process must offer the requesting player a match with almost zero waiting time or else risk losing the interest of the player thereby causing loss to the gaming platform. Matchmaking techniques may take into account the player's skill level, demographic data, connection quality, waiting time, among others.

Typically, every player intending to play a game puts up an amount, whether real or virtual, as an entry fee or as a stake. Thereafter, such a player is matched with another player which has put up the same amount, so as to form a financially even match. The number of players putting up a certain amount at any instant is often denoted as concurrency for that amount.

In many cases, gaming platforms suffer from low concurrency. This may be due to the amount being too low, or too high, or at certain times during the day. As such, a player requesting to be matched during periods of low concurrency may face undesirably longer waiting times, or may not be matched at all before losing interest. A need, therefore, arises for a method and system for matching players in online games during periods of low concurrency and independent of each other's financial involvement.

### SUMMARY

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The present invention provides for a method of matching players requesting to play a virtual game. The method comprises of step of receiving a plurality of matchmaking requests where each of the matchmaking requests signals an intent of one of the players to play the virtual game. Further, for each matchmaking request, a step of identifying game ID and player ID, that has requested matchmaking, is performed.

Further, for a first game ID, a first plurality of game outcomes is identified and for a first player ID, a first entry amount is identified. Corresponding to each of the first plurality of game outcomes and the first entry amount, first plurality of payout amounts for the first player ID and a second player ID corresponding to the first entry amount is identified wherein a second entry amount associated with the second player ID is same as the first entry amount.

Furthermore, a potential match comprising of the first player ID and the second player ID is computed and a third player ID corresponding to the first entry amount is identified wherein a third entry amount associated with the third player ID is different than the first entry amount; and a potential match comprising of the first player ID and the third player ID is computed.

Further, the present invention provides for a system for matching players requesting to play a virtual game. The system as disclosed in the present invention comprises of one or more processing modules and one or more data storage modules.

Furthermore, one or more data storage modules are configured to store at least one of a player profile; a game ID; a plurality of game outcomes corresponding to a game ID and at least one memory module which is operatively coupled to one or more processing modules.

Further, at least one memory modules store instruction which on execution modules causes one or more processing modules to identify a game ID and a player ID from a first matchmaking request made by first player.

Furthermore, the system identifies a plurality of game outcomes, corresponding to the identified game ID and identifies a first entry amount corresponding to the identified player ID.

Further, corresponding to each of the first plurality of game outcomes and the first entry amount, the system identifies a first plurality of payout amounts for the first player ID and identifies a second player ID corresponding to the first entry amount wherein a second entry amount associated with the second player ID is same as the first entry amount.

Furthermore, the system computes a potential match comprising of the first player ID and the second player ID. The system further identifies a third player ID corresponding to the first entry amount wherein a third entry amount associated with the third player ID is different than the first entry amount; and computes a potential match comprising of the first player ID and the third player ID.

It is an object of the invention to provide improved method and system for matching players intending to play a multiplayer online game.

Also, it is an object of the invention to provide improved method and system for matching players that allows asymmetric entry fee and payout.

The independent claims define the invention in various aspects. The dependent claims state selected elements of embodiments according to the invention in various aspects.

This summary is submitted with the understanding that it will not be used to interpret or limit the scope or meaning of the claims. This summary is not intended to identify key features or essential features of the claimed subject matter, nor is it intended to be used as an aid in determining the scope of the claimed subject matter. Other methods, apparatus and systems are also disclosed. Those skilled in the art will recognize additional features and advantages upon reading the following detailed description, and upon viewing the accompanying drawings.

### BRIEF DESCRIPTION OF DRAWINGS

Embodiments according to the claimed subject matter are described below with reference to the drawings. The detailed description references the accompanying figures. The same numbers can be used throughout the drawings to reference like-features and components. As used herein, like terms refer to like elements throughout the description. It should be noted that views of exemplary embodiments are merely to illustrate selected features of the embodiment. The views qualitatively illustrate exemplary features of some embodiments and, therefore, should not be interpreted as being drawn to scale.

FIG. 1 is a block diagram schematically showing an exemplary gaming architecture according to some implementations of the present invention.

FIG. 2 is a block diagram schematically showing an exemplary configuration of the central gaming system 101 according to some implementations of the present invention.

FIG. 3 is a flowchart showing a method of generating asymmetric matches, according to some implementations of the present invention.

### DETAILED DESCRIPTION

For purposes of explanation, numerous specific details are set forth in order to provide a thorough understanding of the claimed subject matter. It may be evident, however, that the claimed subject matter may be practiced without these specific details. Also, in some instances, well-known features are omitted or simplified to clarify the description of the exemplary implementations. In some other instances, well-known features or units or circuits have been shown in block diagram form in order to avoid clutter due to unnecessary detailing.

Reference will now be made to the drawings to describe the present invention in detail. The implementations herein are described in terms of exemplary embodiments. However, it should be appreciated that individual aspects of the implementations may be separately claimed and one or more of the features of the various embodiments may be combined.

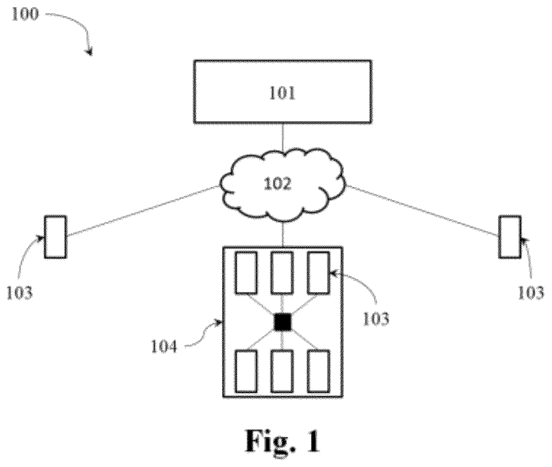

FIG. 1 is a block diagram schematically showing an exemplary gaming architecture according to some implementations of the present invention. The gaming architecture 100 may include a central gaming system 101 and a communications network 102.

The communications network 102 may be any wired and/or wireless network such as internet, WWW, local or wide area network, satellite communication network, Ethernet, PSTN, radio communication network or any such wired and/or wireless communication networks well known in the art. The communications network 102 may also be a combination of such known networks.

The central gaming system 101 may communicate with plurality of gaming terminals through the communications network 102. The gaming terminals may be player terminals 103. Alternatively, or in addition, the gaming terminals may be local gaming systems 104, which are connected, wired or wirelessly, to player terminals 103.

The player terminals 103 may include, but not limited to, mobile phones, desktops, laptops, tablet computers, handheld devices, dedicated gaming consoles, or the like. The local gaming systems 104 may facilitate communication between the player terminals 103 and the central gaming system 101. Alternatively, or in addition, the local gaming systems 104 may administer the games, track game data, player data, regulations data, track or manage financial transactions, and/or may serve any such ancillary functions. The local gaming systems 104 may be configured to serve locations such as airports, educational institutions or gaming convention centers etc. It is to be appreciated here that the gaming architecture 100 is merely exemplary of a number of possible gaming network configurations, without limiting or deviating from the scope of the invention.

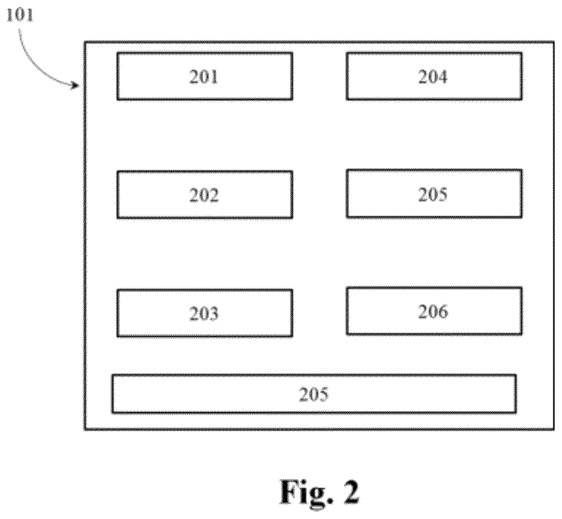

FIG. 2 is a block diagram schematically showing an exemplary configuration of the central gaming system 101 according to some implementations of the present invention. The central gaming system 101 may include one or more processor modules 201, one or more data storage modules 202, one or more input/output modules 203, one or more memory modules 204, one or more networking interface 205, one or more internal networking module 206, and/or at least one matchmaking module 207.

It is to be appreciated by those skilled in the art that although FIG. 2 shows the various components of the central gaming system 101 as co-located, such components may be distributed geographically without deviating from the scope of the invention. Further, the central gaming system 101 according to some other implementations of the invention may include different components and/or configuration than those shown herein. Still further, the different components as shown here are merely functional components, and therefore, such functions may be performed by an integrated module, without deviating from the scope of the invention. In the same spirit, it is to be appreciated by those skilled in the art that different components as shown in FIG. 2 may employ shared resources, such as shared processor, memory, communications, networking or the like.

One or more processor modules 201 may be configured to run various algorithms, computer programs, gaming applications or other applications or programs to facilitate operations of the gaming architecture 100.

One or more data storage modules 202 may be configured to store gaming software and programs. Such gaming software and programs facilitate operations and execution of various virtual games. One or more data storage modules 202 may also store player data, including but not limited to, player IDs and demographic details. Further, one or more data storage modules 202 may store login and fingerprinting data for player terminals 103. The login and fingerprinting data may be used to identify the player terminals 103 through various parameters such as type, make and/or configuration, physical location, virtual location (for instance, IP address), OS version, or the like.

Additionally, one or more data storage modules 202 may be configured to store play data, including game profiles and player profiles. A game profile may include all data relevant to a particular game, such as, but not limited to, number of game instances, total time and/or time per game, scorecards, in-game moves, game modes, number or percentage of players playing the game, and so on and so forth. The game profiles may also include real-time or near real-time data generated during live execution of virtual games.

A player profile may include all data arising out of a player's interaction with the central gaming system 101; such data indicative of the player's performance, skill, activity, preferences, historical data, and so on. The historical data may comprise any data arising out of the interaction of the player with the central gaming system 101. The historical data may correspond to player's statistics parameters such as, but not limited to, player's skill score, win loss tally, recent results, overall points won/lost, recent points won/lost, opponent's skill score, opponent's game score, no. of games played, no. of games played in a time interval, overall games played, time spent or coins/money spent/earned, platform use age, game-time/game, time lapse between games, quits/surrenders frequency, amounts associated in the past, game lobby played and/or game mode, or the like. In addition, the historical data may also indicate the geographic location data, currency data and/or the demographic data of the players.

One or more data storage modules 202 may also be configured to store financial data that is indicative of the financial transactions, whether virtual or real, made through the gaming architecture 100. The financial data is indicative of the fee paid by players, losses, winnings, deposits, withdrawals, bonuses, referrals or any other type of financial transactions made.

It is to be appreciated here that such various categories of data may be stored in a single data storage module, or may be stored in multiple data storage modules, without deviating from the scope of the invention. Such multiple data storage modules may be co-located or distributed geographically. Further, some of these multiple data storage modules may be proprietary of third parties such as banks, fraud units, performance tracking platforms, betting platforms or the like.

One or more input/output modules 203 may include any interface commonly used to communicate with or operate the central gaming system 101, such as a display, keyboard, mouse, joystick, touchpad, microphone, camera, speakers, haptic device or other input-output techniques well known in the art. The central gaming system 101 may also be configured to be operated remotely through any communication network, including, but not limited to, the communications network 102.

One or more memory modules 204 may include any volatile and/or nonvolatile memory such as, but not limited to, RAM, ROM, flash memory or the like well-known in the art. One or more networking interface 205 may be any physical and/or virtual networking interface, known in the art, configured to facilitate communication of the central gaming system 101 with the plurality of gaming terminals 103 through the communications network 102.

One or more internal networking module 206 may be any physical and/or virtual networking interface, known in the art, configured to facilitate communication between various components or modules of the central gaming system 101.

At least one matchmaking module 207 may be configured to identify potential matches, as opponents and/or teammates, for players intending to play an instance of a virtual game.

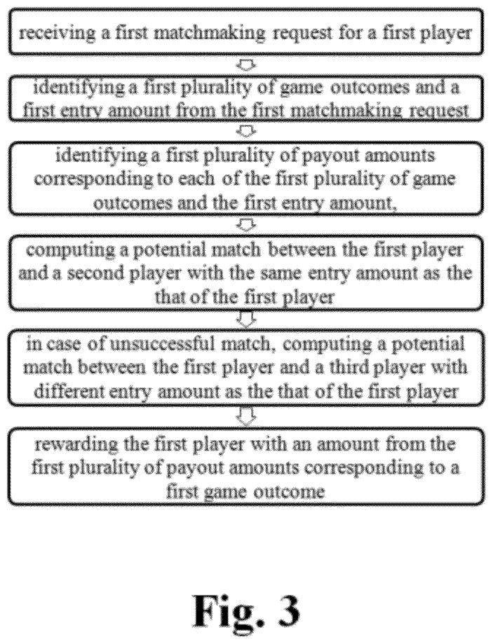

Referring now to FIG. 3, there is shown a method of generating matches, according to some implementations of the present invention. At any instance, there exists a plurality of players intending to play a multiplayer online game, through their respective player terminals 103 which are in communication with the central gaming system 101 through the communications network 102.

Each of these players may make a request to play the game through their respective player terminals 103 which transmits these requests to the central gaming system 101. Any such request may include data corresponding to a player's identity, a requested game-type and the amount associated, among others. The game-type may identify the type and/or the category of the game, such as but not limited to, board game, card game etc. The game-type may also identify the specific type of game, such as but not limited to, poker, rummy, carom or the like. The amount associated may correspond to the entry fee paid by a player in order to participate in a game.

The amount associated may also be indicative of the amount involved in financial transactions (real or virtual), including any in-game purchases, proposed or required to be made by the player during the gameplay.

At the central gaming system 101, each of these requests may be routed to the matchmaking module 207 for setting up potential matches between the plurality of players. The requests may be time-stamped in order for the matchmaking module 207 to process them linearly (FIFO), or the matchmaking module 207 may gather a plurality of requests for batch processing. In some implementations, the matchmaking module 207 may be configured to gather a minimum number of requests. In other implementations, the matchmaking module 207 may be configured to wait for a required time to gather the requests. In still other implementations, the matchmaking module 207 may be configured to dynamically adjust between linear or batch processing.

At the matchmaking module 207, each received request is processed and the data accompanying the request is identified. Matchmaking module 207 may process the data accompanying the request and identify at least one proposed match. The at least one proposed match consists of a plurality of players that are selected to play together in a single instance of the game. At least one proposed match may be of the type 1vs1, 2vs2, 3vs3 and so on. Also, at least one proposed match may be of the type where the plurality of players all plays as opponents, such as in games like rummy, poker, carom, or the like.

In an embodiment of the invention, the matchmaking module 207 identifies, for each matchmaking request, a player ID, a game ID and the amount associated from the data accompanying the request. Corresponding to each player ID, the matchmaking module 207 may retrieve a player profile from one or more data storage modules 202.

Corresponding to each game ID, the matchmaking module 207 may retrieve, identify or define a plurality of game outcomes. A game outcome denotes a possible conclusion into which a game instance may culminate. As an example, in case a first player and a second player engage in a game, one possible game outcome can be the first player winning over the second player. In such a case, the game outcome can be defined as a winning outcome for the first player and a losing outcome for the second player. Likewise, many such game outcomes can be defined for each game instance, which may include, but not limited to, winning outcome, losing outcome, draw outcome, podium finish outcome, partially winning outcome or the others. The matchmaking module 207 may compare a plurality of game IDs to identify at least one proposed match. In an instance, the matchmaking module 207 may only select matchmaking requests with the identical game IDs and corresponding plurality of game outcomes. In an another instance, the matchmaking module 207 may selecting matchmaking requests with game IDs that differ in the plurality of game outcomes from each other, such as in a handicap match.

Further, corresponding to the amount associated, identified from the data accompanying the request, the matchmaking module 207 may retrieve, identify, define or calculate payout amounts for each of the plurality of game outcomes associated with the game ID and the player ID. The payout amount is the reward, whether real, virtual, in cash, kind or equivalent, that is to be received by a player corresponding to the game outcome achieved by the player in the game.

The payout amount may be based on the odds of a player achieving a particular game outcome and may be selected, identified or calculated by one or more processor modules 201 or may be stored in one or more data storage modules 202. Further, the payout amounts may take into consideration supplementary costs, such as but not limited to, transactional fees, platform fee, currency conversion costs, in-game purchases, or the like.

In order to formulate the at least one proposed match, the matchmaking module 207 may, corresponding to a first matchmaking request made by a first player, identify a first player's profile, a first amount associated and a first plurality of game outcomes. The matchmaking module 207 may select a second matchmaking request made by a second player with a second player's profile, a second amount associated and a second plurality of game outcomes.

In an instance of implantation of the invention, the matchmaking module 207 may select the second matchmaking request with the same second amount associated as the first amount associated. The matchmaking module 207 may process the players' profiles data for the first and second player to yield a matching score. The profile data may be indicative of a player's skill level. The matching score may be compared to a first threshold score in order to ascertain whether the match is successful or not. In case the match is not successful, the matchmaking module 207 may select a third matchmaking request with a third amount associated that is different from the first amount associated. The matchmaking module 207 may process the players' profiles data for the first and third player to yield a matching score and compare the matching score to a second threshold score in order to ascertain if the match is successful or not.

One or more processor modules 201 may begin an instance of the game, once the matchmaking process is successfully completed. Each of the plurality of players engaging in the game may have their respective plurality of payout rewards calculated before the start of the game, based on the plurality of game outcomes and the respective amount associated. At the completion of the game, and in correspondence to the resultant game outcome, each of the participating players is awarded their respective payout reward.

The disclosure is operational with numerous other general purposes or special purpose computing system environments or configurations. Examples of well-known computing systems, environments, and/or configurations that may be suitable for use with the disclosure include, but are not limited to, personal computers, server computers, handheld or laptop devices, multiprocessor systems, microprocessor-based systems, set top boxes, programmable consumer electronics, network PCs, minicomputers, mainframe computers, and distributed computing environments that include any of the above systems or devices, and the like.

As used herein, the wording “module” serves only as a representation of the functional aspect, and should not be construed as limiting to only physical or tangible systems or components.

1. A method of matching players requesting to play a virtual game, the method comprising:
receiving a plurality of matchmaking requests, each matchmaking request signalling an intent of one player to play the virtual game;
for each matchmaking request, identifying a game ID and a player ID making the said matchmaking request; for a first game ID, identifying a first plurality of game outcomes;
for a first player ID, identifying a first entry amount;
corresponding to each of the first plurality of game outcomes and the first entry amount, identifying a first plurality of payout amounts for the first player ID, identifying a second player ID corresponding to the first entry amount wherein a second entry amount associated with the second player ID is same as the first entry amount;
computing a potential match comprising of the first player ID and the second player ID;
identifying a third player ID corresponding to the first entry amount wherein a third entry amount associated with the third player ID is different than the first entry amount; and computing a potential match comprising of the first player ID and the third player ID.

2. The method in claim 1, wherein, for calculating the potential match comprising of two player IDs:
accessing a player's profile corresponding to each of the two player IDs;
determining a skill level from the player's profile;
comparing skill levels for the two player IDs to calculate a comparison score;
matching the comparison score with a threshold value.

3. The method in claim 1, wherein, the method further includes:
determining at least one game outcome;
rewarding the first player ID with an amount from the first plurality of payout amounts corresponding to the at least one game outcome.

4. The method in claim 1, wherein, currency of the first entry amount and the currency of the third entry amount is different from each other.

5. A system comprising:
one or more processing modules;
one or more data storage modules, operatively coupled to one or more processing modules, wherein one or more data storage modules are configured to store at least one of:
player profile;
game ID;
a plurality of game outcomes corresponding to a game ID;
at least one memory module operatively coupled to one or more processing modules, wherein the at least one memory module stores instructions which, when executed by one or more processing modules, causes one or more processing modules to, identify a game ID and a player ID from a first matchmaking request made by first player; corresponding to the identified game ID, identify a plurality of game outcomes; corresponding to the identified player ID, identify a first entry amount;
corresponding to each of the first plurality of game outcomes and the first entry amount, identify a first plurality of payout amounts for the first player ID, identify a second player ID corresponding to the first entry amount wherein a second entry amount associated with the second player ID is same as the first entry amount;
compute a potential match comprising of the first player ID and the second player ID;
identify a third player ID corresponding to the first entry amount wherein a third entry amount associated with the third player ID is different than the first entry amount; and
compute a potential match comprising of the first player ID and the third player ID.
